(19) United States
(12) Patent Application Publication
(10) Pub. No.: US 2017/0190919 A1
(43) Pub. Date: Jul. 6, 2017

(54) Microwave Bonding For Coating Compositions

(71) Applicant: Valspar Sourcing, Inc., Minneapolis, MN (US)

(72) Inventors: Jigar K. Mistry, Columbia Heights, MN (US); Jan Peter Frick, Kansas City, MO (US); James Petersen, New Brighton, MN (US)

(73) Assignee: Valspar Sourcing, Inc., Minneapolis, MN (US)

(21) Appl. No.: 15/463,131

(22) Filed: Mar. 20, 2017

Related U.S. Application Data
(63) Continuation of application No. PCT/US2015/050722, filed on Sep. 17, 2015.
(60) Provisional application No. 62/053,559, filed on Sep. 22, 2014.

(51) Int. Cl. C09D 5/03; B01J 2/00; B01J 19/12; B05D 3/06; B05D 1/02

(52) U.S. Cl. CPC C09D 5/03; B05D 3/06; B05D 1/02; C09D 5/035; C09D 5/031; B01J 19/126; B01J 2/006; B01J 2219/1281; B01J 2219/0879

(57) ABSTRACT

A method of bonding two or more components of a free flowing powder composition is described herein. At least a first component, such as for example, a metal effect pigment, and at least a second component, such as for example, an organic material is provided, and one or both components are heated by variable frequency microwave radiation to bond or fuse the components together. Coating compositions and coated articles made by the described method are also provided.

### CROSS-REFERENCE TO RELATED APPLICATION(S)

This application is a continuation of International Application No. PCT/US2015/050722 filed 17 Sep. 2015 which claims priority from U.S. Provisional Application No. 62/053,559 filed 22 Sep. 2014, each of which is incorporated herein by reference in its entirety.

### BACKGROUND

Powder coatings are solvent-free, 100% solids coating systems that have been used as low VOC alternatives to traditional liquid coatings and paints. For functional and aesthetic reasons, inorganic material, organic materials, metallic pigments, and the like are often bonded to powder particles to make coating compositions.

Conventionally, the bonding process involves heating a powder coating in a batch process to a temperature equal to its glass transition temperature through friction or agitation in a jacketed vessel. The pigment is then introduced into the chamber and the mixture is immediately cooled by quenching the chamber or by placing the contents into a cold chamber. The pigment becomes attached to the powder particles with minimal formation of lumps or particle agglomerates. The free-flowing powder made in this manner is a bonded powder. The bonded powder is then sieved to remove any lumps or agglomerates to produce a pigmented powder composition.

This process, however, has several disadvantages. Only a limited amount of pigment can be used, and 100% bonding of all the pigment to the powder does not take place, with some pigment remaining free and unbound. Moreover, the process can be inefficient and time-consuming.

From the foregoing, it will be appreciated that what is needed in the art is a more efficient and effective method of bonding pigments to powder particles.

### SUMMARY

The present invention provides a method for attaching a first component of a powder composition to a second component of the composition by heating the first component or second component using variable frequency microwave radiation.

In one embodiment, a first component and a second component are provided. The first or second component is then heated using variable frequency microwave radiation such that the first component bonds to the second component. In an aspect, the Tg of the second component is lower than Tg of the first component.

In another embodiment, a bonded powder coating composition is provided, wherein the composition is produced by providing a first and second component. These components are mixed and heated using variable frequency microwave radiation such that the first component bonds to the second component to produce a bonded powder composition.

In yet another embodiment, a coated article is described herein. A substrate is provided, and a bonded powder composition is applied to the substrate and cured thereon to form a coating. The powder composition is produced by providing a first and second component. These components are mixed and heated using variable frequency microwave radiation such that the first component bonds to the second component to produce a bonded powder composition.

The above summary of the present invention is not intended to describe each disclosed embodiment or every implementation of the present invention. The description that follows more particularly exemplifies illustrative embodiments. In several places throughout the application, guidance is provided through lists of examples, which examples can be used in various combinations. In each instance, the recited list serves only as a representative group and should not be interpreted as an exclusive list.

The details of one or more embodiments of the invention are set forth in the accompanying drawings and the description below. Other features, objects, and advantages of the invention will be apparent from the description and drawings, and from the claims.

### Selected Definitions

Unless otherwise specified, the following terms as used herein have the meanings provided below.

The term “component” refers to any compound that includes a particular feature or structure. Examples of components include, without limitation, compounds, monomers, oligomers, polymers, pigments, fillers, organic materials, and organic groups contained there. As used herein, the term may also refer to a substrate, particle, sphere, or other material to which one or more components are to be bonded.

The term “crosslinker” refers to a molecule capable of forming a covalent linkage between polymers or between two different regions of the same polymer.

The term “self-crosslinking,” when used in the context of a self-crosslinking polymer, refers to the capacity of a polymer to enter into a crosslinking reaction with itself and/or another molecule of the polymer, in the absence of an external crosslinker, to form a covalent linkage therebetween. Typically, this crosslinking reaction occurs through reaction of complimentary reactive functional groups present on the self-crosslinking polymer itself or two separate molecules of the self-crosslinking polymer.

The term “dispersion” in the context of a dispersible polymer refers to the mixture of a dispersible polymer and a carrier. As used herein, the term may also refer to a mixture of a dispersible polymer in another solid material, including other polymers. The term “dispersion” is intended to include the term “solution.”

The term “thermoplastic” refers to a material that melts and changes shape when sufficiently heated and hardens when sufficiently cooled. Such materials are typically capable of undergoing repeated melting and hardening without exhibiting appreciable chemical change. In contrast, a “thermoset” refers to a material that is crosslinked and does not “melt.”

The term “heat bonded” refers to the process by which a powder composition is allowed to soften via the application of heat and subsequently attach, or fuse to another composition. The terms “heat bonded” and “fused” are used interchangeably herein. The process of heat bonding can be used to attach or fuse together two or more dissimilar materials or two or more similar materials, or combinations thereof.

The term “on”, when used in the context of a coating applied on a surface or substrate, includes both coatings applied directly or indirectly to the surface or substrate. Thus, for example, a coating applied to a primer layer overlying a substrate constitutes a coating applied on the substrate.

Unless otherwise indicated, the term “polymer” includes both homopolymers and copolymers (i.e., polymers of two or more different monomers).

The term “comprises” and variations thereof do not have a limiting meaning where these terms appear in the description and claims.

The terms “preferred” and “preferably” refer to embodiments of the invention that may afford certain benefits, under certain circumstances. However, other embodiments may also be preferred, under the same or other circumstances. Furthermore, the recitation of one or more preferred embodiments does not imply that other embodiments are not useful, and is not intended to exclude other embodiments from the scope of the invention.

As used herein, “a,” “an,” “the,” “at least one,” and “one or more” are used interchangeably. Thus, for example, a coating composition that comprises “an” additive can be interpreted to mean that the coating composition includes “one or more” additives.

Also herein, the recitations of numerical ranges by endpoints include all numbers subsumed within that range (e.g., 1 to 5 includes 1, 1.5, 2, 2.75, 3, 3.80, 4, 5, etc.). Furthermore, disclosure of a range includes disclosure of all subranges included within the broader range (e.g., 1 to 5 discloses 1 to 4, 1.5 to 4.5, 1 to 2, etc.).

### DETAILED DESCRIPTION

In one aspect, the present description provides methods for attaching or bonding two or more components of a powder composition together. In particular, the methods provided herein may be used to attach materials that soften at higher temperatures to materials, including organic materials that soften at lower temperatures, or have lower Tg. The described method involves heating one of the two or more component using microwave radiation, where the radiation may have variable frequency such that one component of a mixture is selectively heated by the radiation.

In an embodiment, the methods described herein include attaching a first component of a powder composition to a second component. In an aspect, the first component is a material that softens at a higher temperature than the second component. The first component may be an organic material, an inorganic material, or mixtures or combinations thereof. In a preferred aspect, the first component is an inorganic material. In an embodiment, for optimal bonding, the first component is an inorganic material, such as, for example, a pigment, and is present in an amount of at least about 1 wt %, preferably at least about 5 wt %, more preferably at least about 10 wt %. In an embodiment, for optimal bonding, the first component is present in an amount of about 1 wt % to 5 wt %, and preferably 7 wt % to 10 wt %, based on the total weight of the composition. In an embodiment, the first component is an inorganic material, including flake and non-flake type material or pigments. Suitable examples of flake type materials include, without limitation, aluminum, mica, silica, titania, Mylar™, and the like. The inorganic material may also be a non-flake material like zinc, tin oxide, stainless steel, and the like, for example. In an embodiment, the first component is an inorganic material, including one or more inorganic pigments. Suitable inorganic pigments include, for example, those derived from mineral compounds, such as oxides or sulfides of one or more metals. Examples of such pigments include, without limitation, TiO₂ (anatase and/or rutile forms), aluminum silicate (e.g., clay), magnesium silicate (e.g., talc), CaCO₃, BaSO₄ (e.g., barytes), iron oxide, zinc oxide, zinc sulfite, and mixtures or combinations thereof. In an aspect, the inorganic pigments described herein are in the form of fine particles having D₅₀ particle size of about 0.01 to about 50 μm, preferably 0.05 to 20 μm, and more preferably 0.1 to 10 μm.

In an embodiment, the first component is an organic material, preferably an organic pigment. Suitable organic pigments include, for example, azo pigments, polycyclic pigments, and the like. Examples of azo pigments include, without limitation, monoazo, diazo, naphthol AS, azo lakes, benzimidazolone, metal complexed azo pigments, and the like. Examples of polycyclic pigments include, without limitation, phthalocyanine, quinacridone, anthroquinone, dioxazine, quinophthalone and the like. In an aspect, the organic pigments described herein have particle size of about 0.01 to 0.1 μm, preferably 0.03 to 0.06 μm.

In an embodiment, the methods described herein include attaching a first component of a powder composition to a second component. In an aspect, the second component is a lower melting material than the first component. The second component may be an organic material, an inorganic material, or mixtures or combinations thereof. In a preferred aspect, the second component is an organic material that is a solid at room temperature. In an aspect, the second component is an organic material, such as a binder resin, for example, and is present in an amount of up to about 99 wt %, preferably up to about 95 wt %, and more preferably, up to about 90 wt %. In an embodiment, for optimal bonding, the second component is present in an amount of about 95 wt % to 99 wt %, and preferably 90 wt % to 93 wt %, based on the total weight of the composition.

In an embodiment, the second component is an organic material, preferably an organic binder suitable for use in a powder coating composition. Such organic binders generally include a film forming resin and optionally a curing agent for the resin. The organic binder may be selected from any resin or combination of resins that provides the desired film properties. Suitable examples of organic binders include thermoset and/or thermoplastic materials, and can be made with epoxy, polyester, polyurethane, polyamide, acrylic, polyvinylchloride, nylon, fluoropolymer, silicone, other resins, or combinations thereof. Thermoset materials are preferred for use as organic binders in powder coating applications, and epoxies, polyesters and acrylics are particularly preferred. If desired, elastomeric resins may be used for certain applications. In an aspect, specific binders are included in the powder compositions described herein depending on the desired end use of the powder-coated substrate. For example, certain high molecular weight polyesters show superior corrosion resistance and are suitable for use on substrates used for interior and exterior applications.

Examples of preferred binders include, without limitation, the following: carboxyl-functional polyester resins cured with epoxide-functional compounds (e.g., triglycidyl-isocyanurate), carboxyl-functional polyester resins cured with polymeric epoxy resins, carboxyl-functional polyester resins cured with hydroxyalkyl amides, hydroxyl-functional polyester resins cured with blocked isocyanates or uretdiones, epoxy resins cured with amines (e.g., dicyandiamide), epoxy resins cured with phenolic-functional resins, epoxy resins cured with carboxyl-functional curatives, carboxyl-functional acrylic resins cured with polymeric epoxy resins, hydroxyl-functional acrylic resins cured with blocked isocyanates or uretdiones, unsaturated resins cured through free radical reactions, and silicone resins used either as the sole binder or in combination with organic resins. The optional curing reaction may be induced thermally, or by exposure to radiation (e.g., UV, UV-vis, visible light, IR, near-IR, and e-beam).

In a preferred aspect, the second component is an organic material, preferably an organic binder, having a lower Tg than the first component. Preferably, the organic binder has a Tg from about 20° C. to about 130° C., more preferably from about 40° C. to about 110° C.

The second component may optionally include dyes or pigments. Various organic or inorganic coloring pigments may be used, as described above, and as known to those of skill in the art. The second component may optionally also include other additives. These other additives can improve the application of the powder coating, the melting and/or curing of that coating, or the performance or appearance of the final coating. Examples of optional additives which may be useful in the powder include: cure catalysts, antioxidants, color stabilizers, slip and mar additives, UV absorbers, hindered amine light stabilizers, photoinitiators, conductivity additives, tribocharging additives, anti-corrosion additives, fillers, texture agents, degassing additives, flow control agents, thixotropes, and other additives known to those of skill in the art.

In an embodiment, the first and second components are included in a masterbatch. As used herein, the term “masterbatch” refers to a concentrated mixture of pigments or other additives that are added to a binder and then heated together in a batch process. Accordingly, in an aspect, the masterbatch will include at least the first component, the second component, or a combination of two or more components is present at an additive level, i.e. in small amounts. For example, where the first component is a pigment to be bonded to the second component, the first component will be present in an amount of about 1 wt % to 5 wt %, and preferably 7 wt % to 10 wt %.

In an embodiment, the powder composition described herein preferably includes at least a first component bonded to a second component, but may also include a third component, fourth component, etc. The methods described herein may be used for attaching or bonding any number of components to other components in a powder composition. The method described herein includes a process for attaching or bonding the two or more components of a powder composition together. Accordingly, in an embodiment, the method includes a step of heating the first and/or second component, or heating a masterbatch that includes the first and second components. This is achieved using variable frequency microwave (VFM) radiation, i.e. using a microwave oven. Conventionally, microwave ovens are configured to operate at a single fixed frequency (typically 2.45 GHz, or the frequency required to heat water). However, metals tend to arc at this frequency and heating tends to be uneven, leading to hot and cold spots. These problems are eliminated by the use of microwave ovens operating in a VFM mode.

VFM technology sweeps a bandwidth of frequencies rapidly to increase the uniformity of microwave energy in comparison to fixed-frequency microwaves. VFM ovens are normally operated to sweep a bandwidth of about 1 GHz around a center frequency every 100 milliseconds. The center frequency can be selected from a variety of bands—typically C-band (5.8 to 7 GHz) or X-band (7.3 to 8.7 GHz), and can be fine-tuned to selectively target specific polymer backbones based on their dielectric properties and absorption frequencies. Therefore, by using VFM technology, it is possible to eliminate problems associated with conventional microwave technology, such as hot and cold spots and arcing of metals, thereby extending the use of microwave technology to various end uses.

Accordingly, in the methods described herein, either the first or second component is selectively heated by VFM, and rapid heat transfer between the heated component and the other component leads to softening of the materials, formation of a heat bond and subsequent attachment of the components. In an embodiment, the first component, preferably an inorganic material, is selectively heated by VFM, leading to a rapid transfer of heat to the lower Tg organic second component. This raises the temperature of the second component to above its Tg and softens the organic material (i.e. second component) enough that the inorganic material (i.e. first component) can become attached or bonded to it.

In an alternate embodiment, the second component, preferably an organic material, is selectively heated by VFM to a temperature at or above its Tg and heat transfer from the second component to the higher melting first component results in the formation of a heat bond. In an aspect, this method of selectively heating the second component may be used even if the first component is an organic material.

In conventional bonding methods, the second component (for example, an organic material) is heated in a batch process to a temperature equal to its Tg through agitation or friction in a jacketed vessel. After agitation, the first component (for example, a flake-type inorganic pigment) is introduced. The mixture is immediately cooled by dumping the contents into a cold chamber. Alternatively, the flake-type pigment may be combined with the organic material prior to heating. When cooling is complete, the flake-type pigment is bonded to the organic material. The free-flowing powder composition formed is a bonded powder. This bonded powder is sieved to remove any unbound pigment or lumps or aggregates formed. In the conventional process, typically about 1 to 5 wt % of bonded powder is removed during sieving and incomplete bonding is common.

Moreover, there is a limit to how much inorganic material may be introduced without having a negative impact on other properties of the powder. Without limiting to theory, this is because a limited number of free surfaces are available for attachment on the inorganic material or on the binder resin. Accordingly, it is conventional to use no more than about 7 to 8 wt %, typically less than about 4 wt % of inorganic material in a conventional bonding process to obtain optimal bonding.

Surprisingly, and in contrast to the conventional method, the methods described herein result in near quantitative bonding of one component to the other. Near quantitative bonding, as used herein, means that at least 90%, preferably 95%, more preferably 99% of the particles of one component become bonded to another component. Also, a significantly larger amount of the first component (an inorganic pigment, for example) may be used in the methods described herein without negative impact on the performance (i.e. aesthetic appearance) of the ultimate cured coating.

In an embodiment, the methods described herein include a step of combining or mixing at least the first or second component prior to heating using VFM in order to obtain a homogenous or uniform mixture. In an aspect, the components are mixed to form a uniform dispersion of one component in the other. In another aspect, the components are mixed by mechanical stirring or by fluidized air to provide a uniform mixture. In each case, the mixing is performed such that the temperature of the mixture due to agitation does not rise above the Tg of the lower melting second component.

In an embodiment, the methods described herein for bonding at least a first and second component of a powder composition using variable frequency microwave radiation is a continuous process. In a continuous process, a mixture of the first and second component is continuously fed into a vessel or tube and a focused beam of variable frequency microwave radiation is used to selectively heat one or more components to allow formation of a heat bond and subsequent attachment or bonding of the components. In an aspect, the continuous method significantly reduces processing time to less than about 10 seconds.

In another embodiment, the methods described herein for bonding at least a first and second component of a powder composition using VFM is a batch process similar to conventional methods currently used in the industry for bonding. In a batch process, a mixture of the first and second component is placed in a vessel or tube capable of being irradiated by microwaves at variable frequencies. A broad beam of VFM radiation is used to selectively heat one or more components to allow formation of a heat bond and subsequent attachment or bonding of the components. Without limiting to theory, it is contemplated that the batch process produces coatings indistinguishable from the continuous process.

The methods described herein offer several advantages over non-bonded and conventionally bonded powders. For example, as the method involves dry blending the inorganic and organic components followed by heating using VFM, the process is simpler than conventional methods and has a shorter bonding time. Moreover, the method of specific heating coupled with a low bonding temperature provides high bonding strength and yield.

Additionally, as the components are not mixed to combine rather than to bond, the thermal, mechanical and sheer stress on the inorganic material (for example, metallic pigments) is relatively low. For example, the aspect ratio of the pigment particles does not change, in contrast to the conventional bonding process. This leads to coatings superior to those formed by conventional methods, with better gloss and aesthetic effects, which can be used in a wide variety of applications and end uses. Another advantage offered by the bonding method described herein involves the appearance of a substrate coated with the bonded composition described herein. The color of a metallic coating can shift with the viewing angle. Without limiting to theory, when an observer looks at a metallic film face-on (i.e. at a normal or near-normal angle), the path length of the light is short, whereas when viewed at a larger angle (flop angle), the path length is longer and the color of the coating appears darker to the observer. For conventionally bonded compositions containing metallic pigments, the face and flop appearances should be the same. However, metal pigments tend to be metameric and may change shape when heated. As a result, the path length of light through the film is altered, leading to a large difference between face and flop. Surprisingly, when metallic pigments are bonded to a powder composition using VFM as described herein, significantly less heat distortion is observed. As a result, the face and flop colors of the coating remain the same.

The final powder may then be applied to an article by various means including the use of fluid beds and spray applicators. Most commonly, an electrostatic spraying process is used, wherein the particles are electrostatically charged and sprayed onto an article that has been grounded so that the powder particles are attracted to and cling to the article. After coating, the article is heated. This heating step causes the powder particles to melt and flow together to coat the article. Optionally, continued or additional heating may be used to cure the coating. Other alternatives such as UV curing of the coating may be used.

In an embodiment, the powder compositions made by the methods described herein are also easier to apply than non-bonded powders or powders bonded by conventional methods. Without limiting to theory, it is believed that the bonding process described herein creates a more uniform particle size with all the inorganic particles physically bonded to the organic particles. Moreover, particles of the powder composition made by the methods described herein are largely spherical, allowing the composition to have better flow characteristics while producing less clogging of the spraying nozzle.

The compositions and methods described herein may be used with a wide variety of substrates. Typically and preferably, the powder coating compositions described herein are used to coat metal substrates, including without limitation, unprimed metal, clean-blasted metal, and pretreated metal, including plated substrates and ecoat-treated metal substrates. Typical pretreatments for metal substrates include, for example, treatment with iron phosphate, zinc phosphate, and the like. Metal substrates can be cleaned and pretreated using a variety of standard processes known in the industry. Examples include, without limitation, iron phosphating, zinc phosphating, nanoceramic treatments, various ambient temperature pretreatments, zirconium containing pretreatments, acid pickling, or any other method known in the art to yield a clean, contaminant-free surface on a substrate.

The compositions and methods described herein may be used in a wide variety of applications or end uses. Exemplary uses include industrial and consumer uses such as, without limitation, heavy machinery, agricultural equipment, construction equipment, building materials, pipe, rebar, appliances, marine components, automotive components, cosmetics, packaging and the like. The compositions or methods described herein can be used in any application or end use where powder coating compositions are used.

Preferably, the coated substrate has desirable physical and mechanical properties, including optimal edge coverage of sharp edges and surface smoothness. Typically, the final film coating will have a thickness of 25 to 200 microns, preferably 50 to 150 microns, more preferably 75 to 125 microns.

The following examples are offered to aid in understanding of the present invention and are not to be construed as limiting the scope thereof. Unless otherwise indicated, all parts and percentages are by weight.

### EXAMPLES

The invention is illustrated by the following examples. It is to be understood that the particular examples, materials, amounts, and procedures are to be interpreted broadly in accordance with the scope and spirit of the inventions as set forth herein. Unless otherwise indicated, all molecular weights are weight average molecular weight. Unless otherwise specified, all chemicals used are commercially available from, for example, Sigma-Aldrich, St. Louis, Mo.

### Example 1

### Continuous Process

Two or more components of a powder coating composition are mixed to form a uniform dispersion of one component in the other. The dispersion is blown continuously through a tube with a narrow beam of variable frequency microwave focused on a specific section of the tube. Within this section of the tube, the microwave radiation heats one or both components to allow heat bond formation and attachment of different particles. The bonded components are then cooled to room temperature. This method has the advantage of rapid heating and agglomeration of more than two particles is minimized.

### Example 2

### Batch Process to Heat Higher Tg Component

Two or more components of a powder coating composition are placed in a mixer inside equipment capable of irradiating microwaves of variable frequency. The mixer could use mechanical stirring or air fluidizing to provide uniform mixing of the components. The mixing should be thorough but not so extensive that the temperature of the mixture due to agitation is raised above the Tg of the lower Tg component. A broad beam of variable frequency microwave radiation is introduced into the mixture such that the higher Tg component is selectively heated to a temperature that is adequate to raise the lower Tg component to above its Tg such that the two components will heat bond or fuse when the particles collide. The bonded components are then cooled to room temperature. The total time and the energy applied are controlled to reduce agglomeration of more than two particles.

### Example 3

### Batch Process to Heat Lower Tg Component

Two or more components of a powder coating composition are placed in a mixer inside equipment capable of irradiating microwaves of variable frequency. The mixer could use mechanical stirring or air fluidizing to provide uniform mixing of the components. The mixing should be thorough but not so extensive that the temperature of the mixture due to agitation is raised above the Tg of the lower Tg component. A broad beam of variable frequency microwave radiation is introduced into the mixture such that the lower Tg component is selectively heated to a temperature that is adequate to raise the lower Tg component to around its Tg such that the two components will heat bond or fuse when the particles collide. The bonded components are then cooled to room temperature. The total time and the energy applied are controlled to reduce agglomeration of more than two particles.

### Example 4

### Batch Process using Multiple Wavelengths

Two or more components of a powder coating composition are placed in a mixer inside equipment capable of irradiating microwaves of variable frequency. The mixer could use mechanical stirring or air fluidizing to provide uniform mixing of the components. The mixing should be thorough but not so extensive that the temperature of the mixture due to agitation is raised above the Tg of the lower Tg component. Multiple wavelengths of microwave radiation are introduced into the mixture in a broad band manner such that the higher Tg component is selectively heated to a temperature that is lower than its Tg. The higher Tg component is then heated to a temperature adequate to raise the lower Tg component above its Tg and the two components will heat bond or fuse when the particles collide. The bonded components are then cooled to room temperature. The total time and energy applied will be controlled to reduce agglomeration of more than two particles. This method has the advantage of not requiring as much heating of the higher Tg component, and can therefore be used with heat-sensitive materials.

### Example 5

### Batch Process using Spray

Two or more components of a powder coating composition are placed in a mixer and mechanically stirred or air fluidized to obtain a homogenous mixture. The mixing is not so extensive as to raise the temperature to near the Tg of even the lower Tg component. The mixture is then sprayed without static charge into an inert chamber and a beam of microwave radiation at variable frequencies is focused on the cloud or stream of powder, quickly heating both components to around the Tg of the lower Tg component. This facilitates fusing or heat bonding of the two components in a homogenous manner. The bonded components are introduced into a cooling chamber to bring them to room temperature. The total time and energy applied is controlled to reduce agglomeration of more than two particles.

### Example 6

### Comparative Example

A bonded coating composition was made according to any of Examples 1 to 5. The composition was sprayed onto test panels at 30 KV and 100 KV to verify bonding and to determine consistency of the composition. For comparison, a non-bonded sample, a control sample of metallics blended with a powder, and a bonded sample made by a conventional bonding method were also sprayed onto test panels. The panels demonstrated that microwave bonded samples are comparable (or even superior) to conventionally bonded powder, with respect to average gloss and aesthetic appearance (such as metallic effect, for example). Results are shown in Table 1 below.

TABLE 1
Comparison of Powder Compositions

| | | | Avg. 20° | Avg. 60° | |
|---|---|---|---|---|---|
| | | Spray | Gloss | Gloss | Travel & Flop |
| Sample | Process | (KV) | (GU) | (GU) | (Aesthetics) |
| Control | Dry Blend | 30 KV | 65 | 92 | Less metallic |
| Sample | | 100 KV | 43 | 80 | effect |
| Standard | Conventionally | 30 KV | 36 | 79 | Good metallic |
| Sample | Bonded | 100 KV | 28 | 68 | effect |
| MB 72 | Microwave | 30 KV | 64 | 98 | Pronounced |
| | Bonded | 100 KV | 51 | 89 | metallic effect; |
| | | | | | Better than |
| | | | | | conventional |
| MB 78 | Microwave | 30 KV | 42 | 80 | Pronounced |
| | Bonded | 100 KV | 41 | 81 | metallic effect; |
| | | | | | Better than |
| | | | | | conventional |

The complete disclosure of all patents, patent applications, and publications, and electronically available material cited herein are incorporated by reference. The foregoing detailed description and examples have been given for clarity of understanding only. No unnecessary limitations are to be understood therefrom. The invention is not limited to the exact details shown and described, for variations obvious to one skilled in the art will be included within the invention defined by the claims. The invention illustratively disclosed herein suitably may be practiced, in some embodiments, in the absence of any element which is not specifically disclosed herein.

What is claimed is:

1. A method of bonding a first component of a free flowing powder composition to a second component of the powder composition, comprising:
providing a first component;
providing a second component;
heating the first component or the second component using variable frequency microwave radiation to bond the first component and the second component together,
wherein the Tg of the second component is lower than the Tg of the first component.

2. The method of claim 1, wherein the first component is selected from organic material, inorganic material, and mixtures thereof.

3. The method of claim 1, wherein the second component is selected from organic material, inorganic material, and mixtures thereof.

4. The method of claim 1, wherein the first component is inorganic material.

5. The method of claim 1, wherein the first component is flake-type material.

6. The method of claim 5, wherein the flake-type material is selected from alumina, mica, MYLAR, glass, and mixtures or combinations thereof.

7. The method of claim 1, wherein the first component is metal.

8. The method of claim 1, wherein the first component is an inorganic pigment.

9. The method of claim 1, wherein the first component is an organic pigment.

10. The method of claim 1, wherein the second component comprises an organic binder having Tg between about 40° C. and 110° C.

11. The method of claim 1, wherein the second component comprises an organic binder, organic pigments, inorganic pigments, additives, and mixtures thereof.

12. The method of claim 1, wherein the second component comprises an organic binder, organic pigments, inorganic pigments, and mixtures thereof.

13. The method of claim 1, further comprising:
mixing at least the first component and second components together to obtain a uniform dispersion; and
heating the dispersion with a focused beam of variable frequency microwave radiation to bond the first and second components.

14. The method of claim 13, further comprising cooling the bonded powder components to room temperature.

15. The method of claim 1, further comprising:
mixing at least the first and second components together to form a uniform mixture; and
using a broad beam of variable frequency microwave radiation to heat the first component to a temperature adequate to raise the temperature of the second component above its Tg.

16. The method of claim 1, further comprising:
mixing at least the first and second components together to form a uniform mixture; and
using a broad beam of variable frequency microwave radiation to heat the second component to a temperature to raise the temperature of the second component to around its Tg.

17. The method of claim 1, further comprising:
mixing at least the first and second components together to form a uniform mixture; and
using a broad beam of microwave radiation at multiple wavelengths to heat the second component to a temperature adequate to raise the temperature of the second component to above its Tg.

18. The method of claim 1, further comprising:
mixing at least the first and second components together to form a uniform mixture;
spraying the mixture into an inert chamber; and
using a focused beam of variable frequency microwave radiation to heat the mixture to a temperature adequate to raise the temperature of the second component to above its Tg.

19. The method of claim 1, wherein the first component is present in an amount greater than about 7 to 8 wt % based on the total weight of the powder composition.

20. The method of claim 1, wherein the amount of the first and second component that remains unbonded after heating is less than about 1 wt % based on the total weight of the powder composition.
